(19) United States
(12) Patent Application Publication
(10) Pub. No.: US 2009/0048404 A1
(43) Pub. Date: Feb. 19, 2009

(54) POLYPROPYLENE RESIN COMPOSITION AND ORIENTED FILM THEREOF

(75) Inventors: Shigeki Kishiro, Ichihara-shi (JP); Hideaki Hori, Sodegaura-shi (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: SUMITOMO CHEMICAL COMPANY, LIMITED, Tokyo (US)

(21) Appl. No.: 12/133,091

(22) Filed: Jun. 4, 2008

(30) Foreign Application Priority Data
Jun. 6, 2007 (JP) 2007-150517

(51) Int. Cl. C08L 23/12

(52) U.S. Cl. 525/240

(57) ABSTRACT

A polypropylene resin composition comprising a propylene polymer obtained by, in a first stage, polymerizing monomers mainly containing propylene to produce a crystalline propylene polymer component (A) having an intrinsic viscosity of not less than 3.0 dl/g and less than 5.0 dl/g, and, in a stage after the first stage, polymerizing monomers mainly containing propylene to produce a crystalline propylene polymer component (B) having an intrinsic viscosity of not less than 1.5 dl/g and less than 2.5 dl/g, wherein the content of the crystalline propylene polymer component (A) in the propylene polymer is not less than 1% by weight and less than 10% by weight, the polypropylene resin composition having a melt flow rate, as measured at a temperature of 230° C. and under a load of 21.18 N, of not less than 1.0 g/10 min and less than 10 g/10 min.

### BACKGROUND OF THE INVENTION

1. Field of the Invention

The present invention relates to a polypropylene resin composition which has excellent suitability for processing and provides an oriented film having few fisheyes, and to an oriented film made of the composition.

2. Description of the Related Art

Conventionally, a propylene polymer obtained by producing a specific crystalline propylene polymer in a first stage and continuously producing a crystalline propylene polymer in a second stage and thereafter has been publicly known.

For example, Japanese Patent Application Laid-Open (JP-A) No. 59-172507 discloses a propylene polymer excellent in processability and in mechanical characteristics, which is obtained by producing 35 to 65% by weight of a crystalline propylene polymer having an intrinsic viscosity of 1.8 to 10 dl/g in a first stage and continuously producing a crystalline propylene polymer having an intrinsic viscosity of 0.6 to 1.2 dl/g in a second stage.

JP-A No. 6-93034 discloses a propylene polymer having an Mw/Mn of more than 20, and being excellent in mechanical characteristics, which is obtained by producing 10 to 60% by weight of a crystalline propylene polymer having an intrinsic viscosity of not less than 2.6 dl/g in a first stage and continuously producing a crystalline propylene polymer having an intrinsic viscosity of not more than 1.2 dl/g in a second stage.

WO 94/26794 discloses polypropylene containing 10 to 35% by weight of a higher molecular weight component, and being excellent in melt strength, which has an M.I. of less than 1.0 when measured at 190° C./10 kg.

WO 98/54233 discloses a polyolefin resin composition, of which the content of a high molecular weight polypropylene having an intrinsic viscosity of 9 to 13 dl/g is 15 to 30% by weight.

Japanese Patent No. 3378517 discloses a propylene polymer which is obtained by producing a crystalline propylene polymer having an intrinsic viscosity of not less than 5 dl/g by polymerization of monomers containing propylene as a main component using a catalyst containing Ti, Mg, and a halogen as indispensable components in a first stage and continuously producing a crystalline propylene polymer having an intrinsic viscosity of less than 3 dl/g by polymerization of monomers containing propylene as a main component in a second stage.

JP-A No. 11-181178 discloses a polyolefin resin composition in which the content of a high molecular weight component having an intrinsic viscosity of 7 to 15 dl/g is 1 to 50% by weight.

Japanese Patent No. 3849329 discloses a method of producing a polypropylene resin composition, in which a higher molecular weight polypropylene having an intrinsic viscosity of 3 to 13 dl/g is polymerized in the first stage, a lower molecular weight polypropylene having an intrinsic viscosity of 0.1 to 5 dl/g is continuously polymerized in the second stage and thereafter, and the obtained polypropylene resin compositions are melted and kneaded in the absence of a cross-linking agent.

Japanese Patent Application National Publication No. 2001-518533 discloses polypropylene which contains a high molecular weight component and a low or middle molecular weight component and has high melt strength.

Japanese patent No. 3761386 discloses a method of producing a polypropylene resin composition containing a component having an MFR of 10 to 1000 g/10 min.

JP-A No. 2004-175933 discloses a polypropylene resin composition which is obtained by multi-stage polymerization and has an Mw/Mn of not less than 5.4 and an Mz/Mn of not less than 20.

However, these documents do not disclose any propylene polymer composition which has excellent suitability for processing and provides an oriented film having few fisheyes.

An object of the present invention is to provide a polypropylene resin composition which has excellent suitability for processing and which provides an oriented film having few fisheyes and to provide an oriented film comprising the obtained polypropylene resin composition.

### SUMMARY OF THE INVENTION

That is, the present invention provides a polypropylene resin composition comprising a propylene polymer obtained by, in a first stage, polymerizing monomers mainly containing propylene to produce a crystalline propylene polymer component (A) having an intrinsic viscosity of not less than 3.0 dl/g and less than 5.0 dl/g, and, in a stage after the first stage, polymerizing monomers mainly containing propylene to produce a crystalline propylene polymer component (B) having an intrinsic viscosity of not less than 1.5 dl/g and less than 2.5 dl/g, wherein the content of the crystalline propylene polymer component (A) in the propylene polymer is not less than 1% by weight and less than 10% by weight, the polypropylene resin composition having a melt flow rate, as measured at a temperature of 230° C. and under a load of 21.18 N, of not less than 1.0 g/10 min and less than 10 g/10 min.

In a preferable embodiment, the crystalline propylene polymer component (A) is a component produced by using a catalyst comprising Ti, Mg and halogen at a polymerization rate of 2,000 g/g-catalyst·hr, and the crystalline propylene polymer component (B) is a component produced by using a catalyst comprising Ti, Mg and halogen at a polymerization rate which is not less than twice the polymerization rate in the production of the crystalline propylene polymer component (A).

Further, the present invention provides an oriented film obtained by shaping the polypropylene resin composition into a film and stretching the film.

### DETAILED DESCRIPTION OF THE PREFERRED EXAMPLES

Hereinafter, the present invention will be described more in detail.

The propylene polymer in the present invention contains a crystalline propylene polymer component (A) and a crystalline propylene polymer component (B).

The crystalline propylene polymer component (A) is obtained by polymerizing monomers mainly containing propylene.

The crystalline propylene polymer component (A) has an intrinsic viscosity of not less than 3.0 dl/g and less than 5.0 dl/g, preferably has an intrinsic viscosity of not less than 3.5 dl/g and less than 4.5 dl/g. If the intrinsic viscosity is less than 3.0 dl/g, the propylene polymer composition may not be superior in suitability for processing and if it is more than 5.0 dl/g, fisheyes may increase in a film obtained by using the propylene polymer composition.

The content of the crystalline propylene polymer component (A) in the propylene polymer is not less than 1% by weight and less than 10% by weight, and is preferably not less than 3% by weight and less than 10% by weight. If the content is less than 1% by weight, the suitability for processing may not be superior and if it is 10% by weight or more, the fluidity may be deteriorated or fisheyes in the obtained film may increase.

The crystalline propylene polymer component (A) is preferably an isotactic propylene polymer such as a propylene homopolymer, or a copolymer of propylene and one or more kinds of monomers selected from the group consisting of ethylene and α-olefins having 4 to 12 carbon atoms. Examples of the α-olefins include 1-butene, 4-methylpentene-1, 1-octene, 1-hexene. In this description, a monomer which is other than propylene and is copolymerized with propylene, is sometimes recited as a “comonomer”.

The crystalline propylene polymer component (A) is preferably a copolymer of propylene and one or more kinds of monomers other than propylene, from the viewpoint of controlling flexibility, transparency, and the like. The content of the monomer other than propylene is preferably not more than 10% by weight, more preferably not more than 5% by weight and furthermore preferably not more than 3% by weight when the monomer is ethylene. The content is preferably not more than 30% by weight, more preferably not more than 20% by weight and furthermore preferably not more than 10% by weight when the monomer is α-olefin. Examples of the preferable crystalline propylene polymer component (A) include a propylene homopolymer, a random copolymer of propylene and not more than 10% by weight of ethylene, a random copolymer of propylene and not more than 30% by weight of butene, and a random terpolymer of propylene, not more than 10% by weight of ethylene, and not more than 30% by weight of butene.

As the crystalline propylene polymer component (A), a propylene-ethylene copolymer containing not less than 1% by weight and not more than 10% by weight of ethylene is particularly preferable in terms of flexibility and transparency. If the content is less than 1% by weight, the flexibility and transparency may be deteriorated.

The intrinsic viscosity of the crystalline propylene polymer component (B) is not less than 1.5 dl/g and less than 2.5 dl/g. If the intrinsic viscosity is not less than 2.5 dl/g, the intrinsic viscosity of the propylene polymers may become higher, leading to the result that the fluidity of the polypropylene resin composition is deteriorated and thus suitability for processing thereof is deteriorated. The intrinsic viscosity [η]B of the crystalline propylene polymer component (B) is a value calculated according to the following expression.

[η]B=([η]T×100−[η]A×WA)/WB

[η]T: intrinsic viscosity of propylene polymer
[η]A: intrinsic viscosity of crystalline propylene polymer component (A)
WA: content of crystalline propylene polymer component (A) (% by weight) in the propylene polymer
WB: content of crystalline propylene polymer component (B) (% by weight) in the propylene polymer

The crystalline propylene polymer component (B) is preferably an isotactic propylene polymer such as a propylene homopolymer, or a copolymer of propylene, ethylene and one or more kinds of monomers selected from the group consisting of an α-olefin having 4 to 12 carbon atoms.

Examples of the particularly preferable crystalline propylene polymer component (B) include a propylene homopolymer, a random copolymer of propylene and not more than 10% by weight of ethylene, a random copolymer of propylene and not more than 30% by weight of butene, and a random terpolymer of propylene, not more than 10% by weight of ethylene, and not more than 30% by weight of butene. The content of ethylene is preferably not more than 7% by weight in the random copolymer of propylene and ethylene, and in the random terpolymer of propylene, ethylene and 1-butene. The content of 1-butene is preferably not more than 20% by weight and more preferably not more than 15% by weight in the random copolymer of propylene and 1-butene, and in the random terpolymer of propylene, ethylene and 1-butene.

The intrinsic viscosity of the propylene polymer is preferably less than 3 dl/g, more preferably not less than 1 dl/g and less than 3 dl/g, furthermore preferably not less than 1.5 dl/g and less than 2.5 dl/g, and particularly preferably not less than 1 dl/g and less than 2 dl/g, from the viewpoint of the processability.

The crystalline propylene polymer component (B) is a propylene polymer component obtained by polymerizing monomers mainly containing propylene in the presence of the crystalline propylene polymer component (A) after the stage of the production of the crystalline propylene polymer component (A). For example, the crystalline propylene polymer component (B) is produced by polymerizing monomers mainly containing propylene in the presence of a stereoregular olefin polymerization catalyst represented by a Ziegler-Natta catalyst to produce the crystalline propylene polymer component (A), and by polymerizing monomers mainly containing propylene in the presence of the catalyst and the produced polymer component (A). A composition which is obtained by separately producing a crystalline propylene polymer component having the intrinsic viscosity of not less than 3.0 dl/g and less than 5.0 dl/g, and a crystalline propylene polymer component having an intrinsic viscosity of not less than 1.5 dl/g and less than 2.5 dl/g, and by successively merely blending both of the components, may be inferior in suitability for processing, and fisheyes tend to increase in sheets and films obtained by using the composition.

Examples of a method of producing the propylene polymer in the present invention include a method of polymerizing monomers in an inert solvent such as hexane, heptane, toluene, xylene, a method of polymerizing monomers in liquid propylene and/or ethylene, a method of polymerizing monomers in gas state by adding a catalyst to gaseous propylene and/or ethylene, and a polymerization method in combination with these methods.

Specific examples of the method of producing the propylene polymer in the present invention include a batch type polymerization method, in which a crystalline propylene polymer component (A) is produced and successively a crystalline propylene polymer component (B) is produced in a single polymerization reactor; a polymerization method, in which, using a polymerization apparatus provided with at least two reactors arranged in series, the crystalline propylene polymer component (A) is produced in the first polymerization reactor, and then the product is transferred from the first polymerization reactor to the second polymerization reactor, and successively the crystalline propylene polymer component (B) is produced in the presence of the crystalline propylene polymer component (A) in the second polymerization reactor.

Particularly, one of efficient methods as the method of producing the propylene polymer is a method of producing a crystalline propylene polymer component (A) in a medium mainly containing liquid propylene and producing a crystalline propylene polymer component (B) in a medium mainly containing gas-phase propylene in the presence of the crystalline propylene polymer component (A), using a Ziegler-Natta catalyst. When this method is employed, the degree of fusion of the polymer powder in the polymerization reactors is suppressed and the degree of the productivity is much better in terms of a yield per unit time, energy necessary for the production and the like.

In the production of the propylene polymer, a catalyst such as a Ziegler-Natta catalyst and a metallocene catalyst is employed to polymerize propylene or a comonomer such as ethylene, and 1-butene.

Examples of the Ziegler-Natta catalyst include a Ti—Mg-based catalyst containing a solid catalyst component obtained by combining a magnesium compound with a Ti compound, a catalyst obtained by combining the solid catalyst component of a magnesium compound combined with a Ti compound further with an organo aluminum compound and, if necessary, a third component such as an electron donating compound.

Preferable examples include catalysts comprising solid catalyst components containing magnesium, titanium, and a halogen, an organic aluminum compound, and an electron donating compound as disclosed in, for example, JP-A Nos. 61-218606, 61-287904, 7-216017, and 2004-67850.

In the propylene polymer, examples of a method of controlling the melting points of the crystalline propylene polymer component (A) and the crystalline propylene polymer component (B) include a method of controlling the amounts of propylene, ethylene, and 1-butene in polymerization reactors in the respective steps of polymerization. Further, examples of a method of controlling the contents of the crystalline propylene polymer component (A) and the crystalline propylene polymer component (B) include a method of controlling the residence time and polymerization temperature and the size of polymerization reactors in the respective steps of polymerization.

The polymerization temperature of the crystalline propylene polymer component (A) is generally within a range of from 20 to 150° C. and preferably from 35 to 95° C. Polymerization in this temperature range is preferable in terms of the productivity and it is also preferable in terms of attainment of the content ratio of the crystalline propylene polymer component (A) and the crystalline propylene polymer component (B).

The amount of the produced crystalline propylene polymer component (A) is preferably not less than 2000 g per gram of the catalyst and per hour, in the production of the crystalline propylene polymer component (A). That is, the polymerization rate is preferably not less than 2000 g/g-cat·hr in the production of the crystalline propylene polymer component (A).

Such a polymerization rate may be attained by properly controlling the polymerization conditions of kinds and amounts of the catalyst, polymerization pressure, and polymerization temperature. By controlling the polymerization conditions, the removal of the catalyst from the product is not required.

The polymerization rate in the production of the crystalline propylene polymer component (B) is preferably not less than twice the polymerization rate in the production of the crystalline propylene polymer component (A). Such a relationship of the polymerization rates may be attained by properly controlling the polymerization conditions of kinds and amounts of the catalyst, polymerization pressure, and polymerization temperature. The polymerization rate in the production of the crystalline propylene polymer component (B) is more preferably not less than three times the polymerization rate in the production of the crystalline propylene polymer component (A). The polymerization temperature in the production of the crystalline propylene polymer component (B) may be equal to or different from the polymerization temperature in the production of the crystalline propylene polymer component (A), and the polymerization temperature is generally within a range of from 20 to 150° C. and preferably from 35 to 95° C.

In a preferable embodiment of the present invention, the crystalline propylene polymer component (A) is a component produced by using a catalyst comprising Ti, Mg and halogen at a polymerization rate of 2,000 g/g-catalyst hr, and the crystalline propylene polymer component (B) is a component produced by using a catalyst comprising Ti, Mg and halogen at a polymerization rate which is not less than twice the polymerization rate in the production of the crystalline propylene polymer component (A).

The propylene polymer is provided as a product after being subjected to deactivation of the catalyst, removal of the solvent, removal of monomers, drying, granulation, and the like, as a post-treatment, if necessary. Steps of the post-treatment may include a step of separating monomers by extracting polymer components and monomers from the polymerization reactors and releasing the pressure, a step of removing solvents and removing remaining monomers in hot nitrogen stream after contact with an deactivating agent such as water, and the like.

The polypropylene resin composition contains the above-mentioned propylene polymer. The polypropylene resin composition contains the propylene polymer as a main component, and the content of the propylene polymer in the polypropylene resin composition is preferably 70% by weight or more and more preferably 90% by weight or more.

The polypropylene resin composition of the present invention may contain the other resin components such as polyolefin polymers, e.g. polyethylene, poly(1-butene), styrene resins, ethylene/α-olefin copolymer rubber, ethylene-propylene-diene copolymer rubber.

The polypropylene resin composition of the present invention may contain additives such as a neutralizating agent, an antioxidant, a weatherproof stabilizer, a flame retardant, an antistatic agent, a plasticizer, a lubricant, an agent for preventing copper harm, and a silicon dioxide powder.

The polypropylene resin composition of the present invention has a melt flow rate, as measured at 230° C. and a load of 21.18 N, of not less than 1.0 g/10 min and less than 10 g/10 min, preferably not less than 1.5 g/10 min and less than 9.0 g/10 min, and more preferably not less than 2.0 g/10 min and less than 8.0 g/10 min. If the composition has a melt flow rate of less than 1.0 g/10 min, the fluidity of the composition may become inferior and the processability of the composition may also become inferior, and if the composition has a melt flow rate of not less than 10 g/10 min, it may become difficult to shape a film.

When the polypropylene resin composition of the present invention contains no resin components other than the propylene polymer, the melt flow rate of the polypropylene resin composition of the present invention is preferably not less than the melt flow rate of the propylene polymer.

The polypropylene resin composition of the present invention preferably has the melt tension of less than 2.5 g determined by the pulling method.

Examples of the method of producing the polypropylene resin composition of the present invention include, a method of mixing a propylene polymer, and if necessary, other resin components and additives with a mixing apparatus such as a tumbler mixer, a Henschel mixer, and a ribbon blender, and successively melting and kneading the obtained mixture with a uniaxial extruder, a twin screw extruder, a Bambury mixer, etc.

The polypropylene resin composition of the present invention can be used suitably for a wide range of applications by extrusion forming, injection forming, vacuum forming, and foam forming. In particular, the composition is preferably used for extrusion forming and shaped in films and sheets.

An oriented film of the present invention is an oriented film obtained by shaping the polypropylene resin composition of the present invention into a film and stretching the film.

A film shaping and stretching method in order to obtain the oriented film of the present invention is not particularly limited, and examples thereof generally include a longitudinal uniaxial stretching method, a transverse uniaxial stretching method, a sequential biaxial stretching method, a simultaneous biaxial stretching method, or a tubular biaxial stretching method described below. In a film without stretching, fisheyes may increase.

The longitudinal uniaxial stretching method is a method of melting the polypropylene resin composition by an extruder, successively extruding the composition by a T die, and cooling and solidifying the extruded composition in a sheet-like state by a cooling roll, and then, preheating and stretching the obtained film in the longitudinal direction by a series of heating rolls to shape a film.

The transverse uniaxial stretching method is a method of melting the polypropylene resin composition by an extruder, successively extruding the composition by a T die, and cooling and solidifying the extruded composition in a sheet-like state by a cooling roll, and then holding both ends of the obtained film respectively by chucks arranged in two rows along the flowing direction, and stretching the obtained film in the transverse direction by widening the distance between the two rows of the chucks in a heating oven including a preheating part, a stretching part, and a heat treatment part, to shape a film.

The sequential biaxial stretching method is a method of melting the polypropylene resin composition in an extruder, successively extruding the composition through a T die, and cooling and solidifying the extruded composition in a sheet form by a cooling roll, and then preheating and stretching the obtained sheet in the longitudinal direction by a series of heating rolls, and thereafter holding both ends of the obtained film respectively by chucks arranged in two rows along the flowing direction, and stretching the obtained film in the transverse direction by widening the distance between the two rows of the chucks in a heating oven including a preheating part, a stretching part, and a heat treatment part, to shape a film. The melting temperature of the resin composition is generally in a range of 230° C. to 290° C., although it depends on the molecular weight. The longitudinal stretching temperature is generally 130 to 150° C., and the longitudinal stretching ratio is generally 4 to 6 times, the transverse stretching temperature is generally 150 to 165° C., and the transverse stretching ratio is generally 8 to 10 times.

The simultaneous biaxial stretching method is a method of melting the polypropylene resin composition in an extruder, successively extruding the composition through a T die, and cooling and solidifying the extruded composition in a sheet form by a cooling roll, and then holding both ends of the obtained film respectively by chucks arranged in two rows along the flowing direction, and stretching both of the ends in both of the longitudinal direction and the transverse direction by widening the distance between the two rows of the chucks and widening the intervals of the chucks in each row in a heating oven including a preheating part, to shape a film.

The tubular biaxial stretching method is a method of melting the polypropylene resin composition in an extruder, successively extruding the composition through a circular die, and cooling and solidifying the extruded composition in a tubular form in a water bath, and then preheating the obtained tube in a heating oven or by a series of heat rolls, and thereafter passing the obtained tube through low speed nip rolls and rolling the obtained tube by high speed nip rolls to stretch in the flowing direction, wherein the obtained tube is expanded by the inner pressure of the air accumulated between the low speed nip rolls and high speed nip rolls to stretch the tube also in the width direction, to shape a film.

The oriented film of the present invention may be in a single layer structure or in two or more multi-layer structure composed of two or more layers, and when the oriented film has the multi-layer structure, the oriented film has a layer comprising the above-mentioned polypropylene resin composition on at least one surface.

While the thickness of the oriented film of the present invention can be determined properly in accordance with application, and it is not particularly limited, and it is generally 5 to 100 μm and preferably 10 to 60 μm. The film is widely employed for wrapping such as wrapping for foods, wrapping for fibers, and wrapping for miscellaneous goods.

The oriented film of the present invention may be surface-treated by a commonly and industrially employed method such as corona discharge treatment, flame treatment, plasma treatment, and ozone treatment.

### EXAMPLES

Hereinafter, the present invention will be illustrated with reference to Examples, however, the present invention should not be limited to these Examples.

### (1) Contents of Crystalline Propylene Polymer Component (A) and Crystalline Propylene Polymer Component (B) (% by Weight)

The contents were calculated from the mass balance in the production when the propylene polymer was produced by a method for producing the polypropylene polymer composition of the present invention. The contents were calculated from the mixing ratio when the propylene polymer was produced by merely blending the crystalline propylene polymer component (A) and the crystalline propylene polymer component (B).

(2) Intrinsic Viscosity of Polymer Components (Unit: dl/g)

Measurement was carried out using an Ubbelohde viscometer in Tetralin at 135° C. The intrinsic viscosity of the crystalline propylene polymer component (B) was calculated from the calculation expression described in this description, using the intrinsic viscosities of the crystalline propylene polymer component (A) and the propylene polymer.

### (3) Contents of Comonomers (Unit: % by Weight)

According to the method described in page 616 and subsequent pages of Polymer Handbook (1995, issued by Kinokuniya), the contents were measured by infrared spectroscopy.

### (4) Melting Point (Tm, Unit: ° C.)

After about 10 mg of each specimen was melted at 220° C. in a nitrogen atmosphere using a differential scanning calorimeter (DSC manufactured by Perkin Elmer), the specimen was quickly cooled to 150° C. After being kept at 150° C. for 1 minute, the specimen was cooled to 50° C. at a cooling speed of 5° C./min.

Thereafter, the specimen was held at 50° C. for 1 minute and successively heated at 5° C./min, and in the obtained melting endothermic curve, the peak temperature of the maximum peak was defined as Tm (melting point), whose decimals were rounded off. If there were a plurality of peaks, the peak at the higher temperature side was employed.

Tm of indium (In) measured using the measurement apparatus at a cooling and heating rate of 5° C./min was 156.6° C.

(5) Melt Flow Rate (MFR, Unit: g/10 min)

Measurement was carried out at a temperature of 230° C. and a load of 21.18 N according to JIS K7210.

### (6) Melt Tension (MT, Unit: g)

Measurement was carried out in the following conditions using a melt tension meter manufactured by Toyo Seiki Seisaku-Sho Co., Ltd.

### Orifice: L/D=4 (D=2 mm)

Measurement temperature: 190° C.
Preheating time: 10 minutes
Extrusion speed: 5.7 mm/min
Pulling speed: 15.6 m/min
(7) Count of Fisheyes (Unit: piece/100 cm²)

Using a desktop-based defect inspection apparatus GX70 LT manufactured by Mamiya-OP, defects with 200 μm or more were counted in a range of 16.35 cm×12 cm and the number of fisheyes (FE) per 100 cm² was calculated.

### Example 1

### Synthesis of Solid Catalyst and Preliminary Activation

Preliminary activation was carried out by adding 1.5 L of sufficiently dehydrated and degassed n-hexane, 37.5 mmol of triethylaluminum, and 3.75 mmol of cyclohexylethyldimethoxysilane to 15 g of a solid catalyst component containing magnesium, titanium and a halogen produced according to Examples of JP-A No. 2004-067850 and continuously supplying 15 g of propylene while keeping the temperature of a reactor at 5 to 15° C.

### (Production of Propylene Polymer)

Two polymerization reactors were connected in series and polymerization was carried out by the following procedure.

In a polymerization reactor having an inner volume of 20 L made of SUS as a first reactor, while 40 kg/hr of liquid propylene, 5 kg/hr of 1-butene, and 1 L/hr of hydrogen were supplied and the polymerization temperature and the polymerization pressure were kept at 58° C. and 2.2 MPa, respectively, 41.8 mmol of triethylaluminum, 10.7 mmol of cyclohexylethyldimethoxysilane, and 0.61 g/hr of the preliminarily activated solid catalyst component were continuously supplied to carry out polymerization. The production amount of the propylene polymer (component A) in this polymerization reactor was 1.2 kg/hr. A portion of the polymer (component A) was sampled and it was found that the intrinsic viscosity was 4.2 dl/g, the content of 1-butene was 3.1% by weight, and the content of propylene was 96.7% by weight. The propylene polymer (component A) was all continuously transferred to the second reactor without being deactivated.

A fluidized bed reactor having an inner volume of 1 m³ and equipped with a stirrer was used as the second reactor and while propylene, ethylene, 1-butene and hydrogen were supplied to adjust the ethylene concentration to be 1.45 vol % in a gas phase, the 1-butene concentration to be 14.1 vol % in the gas phase, and the hydrogen concentration to be 1.3 vol % in the gas phase at a polymerization temperature of 80° C. and polymerization pressure of 1.8 MPa, propylene polymerization was carried out in the presence of the catalyst-containing polymer transported from the first reactor. At the outlet of the second reactor, 20.2 kg/hr of a propylene polymer was obtained. The intrinsic viscosity of this polymer was 1.9 dl/g, the ethylene content was 2.1% by weight, the 1-butene content was 11.2% by weight and the melting point was 130° C. and the MFR was 4.0 g/10 min.

From the above-mentioned results, the production amount of the propylene polymer (component B) in the second reactor was 19.0 kg/hr and the polymer weight ratio of the (component A) and the (component B) was 5.9:94.1 and the intrinsic viscosity of the (component B) was found to be 1.7 dl/g by calculation.

### (Production of Film)

The propylene polymer finally obtained by the polymerization in an amount of 100 parts by weight was mixed with 0.05 parts by weight of pentaerythrityl-tetrakis[3-(3,5-di-tert-butyl-4-hydroxyphenyl)propionate] (trade name: IRGANOX 1010), 0.15 parts by weight of a phosphorus-based antioxidant, tris(2,4-di-tert-butylphenyl) phosphite (trade name: IRGAFOS 168), 0.10 parts by weight of synthesized silica with an average particle diameter of 2.3 μm (measured by Coulter method) (trade name: Sylysia 430, manufactured by Fuji Silysia Chemical Ltd.), 0.05 parts by weight of erucamide, and 0.05 parts by weight of talc and the obtained mixture was melted and kneaded at 220° C. to obtain pellets with the MFR of 4.3 g/min. The melt tension of the pellets was 1.3 g.

### (Evaluation of Suitability for Processing)

The obtained pellets (for a surface layer) and Sumitomo Noblen FS 2011 DG3 (melting point 159° C., MFR=2.5 g/10 min) (for a substrate layer) were respectively melted and extruded separate extruders at 230° C. and 260° C. and supplied to a single coextrusion T die. The resins extruded through the T die in two-type two-layer configuration (chill roll side/anti-chill roll=FS 2011DG3/sample) were cooled by cooling rolls at 30° C. to process a cast sheet with a thickness of about 1 mm. Die deposit at the die outlet in the anti-chill side was observed visually and evaluated after 1 hour from the processing.

The die deposit was evaluated according to the following criteria.

o: Die deposit adhered to the die outlet over a width which was less than ⅓ the width of the die outlet.
Δ: Die deposit adhered to the die outlet over a width which was from ⅓ to ⅔ the width of the die outlet.
x: Die deposit adhered to the die outlet over a width which was not less than ⅔ the width of the die outlet.

The evaluation results are shown in Table 2.

### (Evaluation of Biaxially Oriented Film)

The obtained pellets for the surface layer were melted and extruded by an extruder at a resin temperature of 220° C. and supplied to a T die. The resin extruded through the T die was cooled with cooling rolls at 25° C. to obtain a cast sheet with a thickness of about 200 μm.

The obtained cast sheet was stretched 4 times as large in a longitudinal direction at a stretching temperature of 110° C. by roll circumferential velocity difference and successively stretched 4 times as large in the transverse direction at a stretching temperature of 125° C. in a heating oven to obtain a biaxially oriented film with a thickness of 12 μm. The fisheyes of the obtained film was evaluated. There were 7.8 fisheyes/100 cm².

### Example 2

The component A and the component B were produced as shown in Table 1, by changing the amounts of propylene, ethylene, 1-butene, and hydrogen in the first reactor and the second reactor in the production of the propylene polymer in Example 1, and a powder having an MFR of 3.4 g/10 min was produced. The pelletization of the powder was carried out. The obtained pellets, cast sheet and film were evaluated in the same manner as in Example 1.

The evaluation results are shown in Table 2.

### Example 3

The component A and the component B were produced as shown in Table 1, by changing the amounts of propylene, ethylene, 1-butene, and hydrogen in the first reactor and the second reactor in the production of the propylene polymer in Example, and a powder having an MFR of 3.4 g/10 min was produced. The pelletization of the powder was carried out. The obtained pellets, cast sheet and film were evaluated in the same manner as in Example 1.

The evaluation results are shown in Table 2.

Further, the obtained pellets were extruded at a resin temperature of 220° C. and a discharge amount of 12 kg/hr using an extruder of φ 50 mm and equipped with a coat hanger-type T die with a width of 400 mm and cooled at a chill roll temperature of 30° C. and a line velocity of 10 m/min in an air chamber cooling manner to produced a film with a thickness of 15 μm. The fisheyes of the obtained film were evaluated.

The evaluation results are shown in Table 2.

### Example 4

The component A and the component B were produced as shown in Table 1, by changing the amounts of propylene, ethylene, 1-butene, and hydrogen in the first reactor and the second reactor in the production of the propylene polymer in Example 1, and the pelletization was carried out. The obtained pellets, cast sheet and film were evaluated in the same manner as in Example 3.

The evaluation results are shown in Table 2.

### Example 5

The component A and the component B were produced as shown in Table 1, by changing the amounts of propylene, ethylene, 1-butene, and hydrogen in the first reactor and the second reactor in the production of the propylene polymer in Example 1, and the pelletization was carried out. The obtained pellets, cast sheet and film were evaluated in the same manner as in Example 3.

The evaluation results are shown in Table 2.

### Example 6

The component A and the component B were produced as shown in Table 1, by changing the amounts of propylene, ethylene, 1-butene, and hydrogen in the first reactor and the second reactor in the production of the propylene polymer in Example 1, and the pelletization was carried out. The obtained pellets, cast sheet and film were evaluated in the same manner as in Example 3.

The evaluation results are shown in Table 2.

### Comparative Examples 1 to 4

The component A and the component B were produced as shown in Table 1, by changing the amounts of propylene, ethylene, 1-butene, and hydrogen in the first reactor and the second reactor in the production of the propylene polymer in Example 1, and pelletization was carried out. The obtained pellets, cast sheet and film were evaluated in the same manner as in Example 1.

The evaluation results are shown in Table 2.

TABLE 1

| | Component A | | | | Component B | Propylene polymer | | | MFR | |
|---|---|---|---|---|---|---|---|---|---|---|
| | [η] | Ethylene | Butene | Content | [η] | [η] | Ethylene | Butene | (pellet) | MT |
| | dl/g | wt % | wt % | wt % | dl/g | dl/g | wt % | wt % | g/10 min | g |
| Example 1 | 4.2 | 0 | 3.1 | 5.9 | 1.8 | 1.9 | 2.1 | 11.2 | 4.3 | 1.3 |
| Example 2 | 4.0 | 0 | 4.0 | 5.4 | 1.8 | 1.9 | 2.1 | 8.7 | 4.5 | 1.5 |
| Example 3 | 3.7 | 0 | 3.8 | 5.6 | 1.8 | 1.9 | 2.3 | 9.1 | 4.1 | 1.5 |
| Example 4 | 3.5 | 0 | 4.0 | 6.5 | 1.7 | 1.8 | 2.1 | 9.5 | 4.5 | 1.2 |
| Example 5 | 4.0 | 1.6 | 0 | 7.8 | 1.9 | 2.0 | 4.1 | 0 | 2.8 | 2.2 |
| Example 6 | 4.1 | 1.4 | 2.4 | 8.5 | 1.9 | 2.1 | 1.8 | 10.0 | 2.4 | 2.3 |
| Comparative | 2.5 | 0 | 4.3 | 4.3 | 1.8 | 1.8 | 1.7 | 9.4 | 4.2 | 1.2 |
| Example 1 | | | | | | | | | | |
| Comparative | 5.6 | 0 | 2.6 | 7.0 | 1.6 | 1.9 | 2.0 | 10.5 | 4.0 | 1.5 |
| Example 2 | | | | | | | | | | |
| Comparative | 3.7 | 0 | 3.9 | 4.7 | 1.3 | 1.5 | 1.9 | 10.0 | 13.4 | 0.5 |
| Example 3 | | | | | | | | | | |
| Comparative | 3.7 | 0 | 3.9 | 16.2 | 1.6 | 2.0 | 1.9 | 10.3 | 4.4 | 1.7 |
| Example 4 | | | | | | | | | | |

TABLE 2

| | | FE (un- | |
|---|---|---|---|
| | FE (oriented) | oriented) | |
| | FE/100 cm² | FE/100 cm² | Die deposit |
| Example 1 | 7.8 | — | ∘ |
| Example 2 | 3.4 | — | ∘ |
| Example 3 | 4.9 | 41 | ∘ |
| Example 4 | 1.0 | 15 | ∘ |
| Example 5 | 2.5 | — | ∘ |
| Example 6 | 1.8 | — | ∘ |
| Comparative | 1.0 | — | x |
| Example 1 | | | |
| Comparative | 52 | 265 | ∘ |
| Example 2 | | | |
| Comparative | 180 | — | x |
| Example 3 | | | |
| Comparative | 210 | — | x |
| Example 4 | | | |

The present invention provides a polypropylene resin composition which has excellent suitability for processing and which provides an oriented film having few fisheyes.

1. A polypropylene resin composition comprising a propylene polymer obtained by, in a first stage, polymerizing monomers mainly containing propylene to produce a crystalline propylene polymer component (A) having an intrinsic viscosity of not less than 3.0 dl/g and less than 5.0 dl/g, and, in a stage after the first stage, polymerizing monomers mainly containing propylene to produce a crystalline propylene polymer component (B) having an intrinsic viscosity of not less than 1.5 dl/g and less then 2.5 dl/g, wherein the content of the crystalline propylene polymer component (A) in the propylene polymer is not less than 1% by weight and less than 10% by weight, the polypropylene resin composition having a melt flow rate, as measured at a temperature of 230° C. and under a load of 21.18 N, of not less than 1.0 g/10 min and less than 10 g/10 min.

2. The polypropylene resin composition according to claim 1, wherein the crystalline propylene polymer component (A) is a component produced by using a catalyst comprising Ti, Mg and halogen at a polymerization rate of 2,000 g/g-catalyst·hr, and the crystalline propylene polymer component (B) is a component produced by using a catalyst comprising Ti, Mg and halogen at a polymerization rate which is not less than twice the polymerization rate in the production of the crystalline propylene polymer component (A).

3. The polypropylene resin composition according to claim 1, wherein the crystalline propylene polymer component (A) is one component selected from the group consisting of a propylene homopolymer, a random copolymer of propylene and not more than 10% by weight of ethylene, a random copolymer of propylene and not more than 30% by weight of butane, and a random terpolymer of propylene, not more than 10% by weight of ethylene and not more than 30% by weight of butane.

4. The polypropylene resin composition according to claim 1, wherein the crystalline propylene polymer component (B) is one component selected from the group consisting of a propylene homopolymer, a random copolymer of propylene and not more than 10% by weight of ethylene, a random copolymer of propylene and not more than 30% by weight of butane, and a random terpolymer of propylene, not more than 10% by weight of ethylene and not more than 30% by weight of butane.

5. An oriented film obtained by shaping the polypropylene resin composition according to claim 1 into a film and stretching the film.

6. An oriented film obtained by shaping the polypropylene resin composition according to claim 2 into a film and stretching the film.

7. An oriented film obtained by shaping the polypropylene resin composition according to claim 3 into a film and stretching the film.

8. An oriented film obtained by shaping the polypropylene resin composition according to claim 4 into a film and stretching the film.
